(19) United States
(12) Patent Application Publication
(10) Pub. No.: US 2026/0356771 A1
(43) Pub. Date: Nov. 12, 2026

(54) Process for Producing Sulfate of Potash from a Wood Pulping Operation

(71) Applicant: Veolia Water Technologies, Inc., Cary, NC (US)

(72) Inventors: Michael S. Begley, Lisle, IL (US); Peter Zurowski, La Grange, IL (US)

(21) Appl. No.: 19/135,450

(22) PCT Filed: Dec. 7, 2023
(86) PCT No.: PCT/US2023/082820

§ 371 Date: Jun. 4, 2025

Related U.S. Application Data
(60) Provisional application No. 63/431,221, filed on Dec. 8, 2022.

(51) Int. Cl. C05D 1/02; C01D 5/00; D21C 11/00

(52) U.S. Cl. CPC C05D 1/02; C01D 5/00; D21C 11/0007

(57) ABSTRACT

The present invention relates to a process for recovering sulfate of potash from ash taken from a recovery boiler in a wood pulping operation. The ash is dissolved in water and the resulting solution is subjected to evaporation that produces a concentrated dissolved ash solution that is then subjected to treatment in the glaserite crystallizer. The glaserite crystallizer yields glaserite crystals that are contacted with water or condensate that has been chilled in a chiller to a temperature of 0 °C to 25 °C or by chilling the crystallizer brine to −10 °C to 25 °C. The glaserite crystals and chilled water are directed into an SOP crystallizer where the sodium sulfate and potassium sulfate of the glaserite crystals dissolve in the chilled water to form a solution containing both sodium sulfate and potassium sulfate. A portion of the potassium sulfate in excess of its solubility limit will re-crystallize as SOP. Through a solid-liquid separation process, the SOP is recovered.

### RELATED APPLICATIONS

This application claims priority from U.S. Provisional App. No. 63/431,221, filed 8 Dec. 2022, the disclosure of which is incorporated by reference herein in its entirety.

### FIELD OF THE INVENTION

The present invention relates to a process for producing sulfate of potash (aka K₂SO₄ or SOP), and more particularly to a process for producing sulfate of potash in the course of treating ash produced in a wood pulping operation.

### BACKGROUND OF THE INVENTION

Sulfate of potash is an excellent high potassium, low chloride fertilizer that provides essential nutrients that aid plants in resisting disease and pests and is generally considered a high quality and valued fertilizer that produces quality crops. While there are numerous ways of producing sulfate of potash, in recent years there has been a growing interest in producing sulfate of potash as a by-product of treating industrial waste streams since many such waste streams include potassium and sulfate. The problem with these processes insofar as recovering SOP is concerned is that they are inefficient and vulnerable to contamination by sodium salts. Where there is an overabundance of sodium entering the SOP crystallizer, SOP yields are relatively low, making the process uneconomical. As the solubility of sodium sulfate is relatively temperature independent while the solubility of SOP is strongly temperature dependent, operation of the system at colder temperatures provides significant yield and operability improvements.

### SUMMARY OF THE INVENTION

The present invention relates to a process of producing SOP in the course of treating ash generated in a wood pulping operation. In the course of treating ash via a crystallization process, a glaserite slurry containing glaserite (3K₂SO₄·Na₂SO₄) crystals is produced. The glaserite crystals are separated from the slurry. In one embodiment, water or condensate is directed to a chiller where the water or condensate is cooled to a temperature of 0 °C to 25 °C to form chilled water. The chilled water and the glaserite crystals are directed into an SOP crystallizer where the chilled water contacts the glaserite crystals. In the SOP crystallizer, sodium sulfate and potassium sulfate dissolve from the glaserite crystals into the chilled water. Thereafter, a substantial portion of the potassium sulfate re-crystallizes as SOP. The amount of SOP crystallized is inversely related to the temperature, therefore more SOP is precipitated at lower temperatures. This yields a sodium sulfate-rich solution containing the re-crystallized SOP in the SOP crystallizer. The sodium sulfate-rich solution is directed to a solid-liquid separator that separates the re-crystallized SOP from the sodium sulfate-rich solution. This SOP recovery process is less sensitive to yield reduction due to sodium contamination that may result from upstream operational or chemistry instability. Moreover, this SOP recovery process tends to minimize or reduce process water requirements.

More particularly, in one embodiment, the present invention entails:

A process for recovering sulfate of potash (SOP) from ash produced in a wood pulping operation, the process comprising:
A. recovering ash containing potassium, chloride, sulfate carbonate and sodium from a recovery boiler of the wood pulp operation;
B. mixing the ash with an aqueous solution to form a dissolved ash solution;
C. concentrating the dissolved ash solution in an evaporator to form a concentrated dissolved ash solution;
D. directing the concentrated dissolved ash solution to a glaserite crystallizer and producing a glaserite slurry containing glaserite crystals;
E. separating the glaserite crystals from the glaserite slurry;
F. directing water to a chiller;
G. chilling the water in the chiller to a temperature of 0 °C to 25 °C to form cooled water;
H. directing the glaserite crystals and chilled water into an SOP crystallizer;
I. dissolving the glaserite crystals in the chilled water in the SOP crystallizer to yield a solution containing sodium sulfate and potassium sulfate;
J. re-crystallizing the potassium sulfate as SOP in the SOP crystallizer, yielding a sodium sulfate-rich solution in the SOP crystallizer; and
K. directing the sodium sulfate-rich solution containing the re-crystallized SOP to a solid-liquid separator and separating the re-crystallized SOP from the sodium sulfate-rich solution.

In another embodiment, the solution contained in the SOP crystallizer is circulated through a chiller in order to maintain the temperature of the solution in the SOP crystallizer at −10 °C to 25 °C. In one embodiment, the solution in the SOP crystallizer is a mixture of water that is directed into the SOP crystallizer and a brine produced by the SOP crystallizer in the course of dissolving glaserite crystals. This solution is sometimes simply referred to as an aqueous solution. In any event, the process of recovering SOP from the glaserite crystals remains the same. That is, the glaserite crystals are dissolved in the SOP crystallizer, producing a sodium sulfate and potassium sulfate solution. After the potassium sulfate is dissolved, it crystallizes as SOP and through a solid-liquid separator is recovered from a sodium sulfate-rich solution.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic illustration showing a basic SOP recovery process.

FIG. 2 is a schematic illustration showing a process for treating ash from a recovery boiler of a wood pulping operation and illustrating a process for treating the ash that recovers SOP.

FIG. 3 is a schematic illustration similar to FIG. 2 but illustrates a slightly different process for recovering SOP.

### DESCRIPTION OF PREFERRED EMBODIMENTS

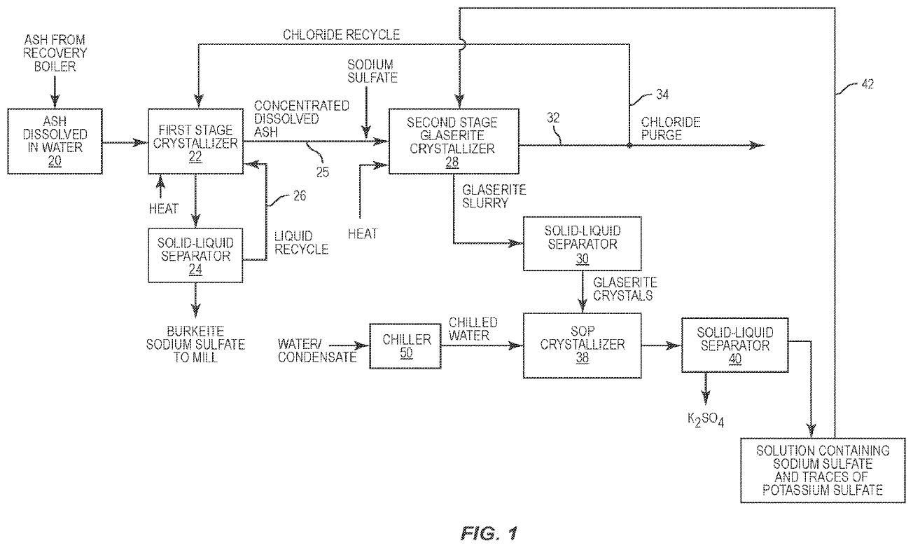

With further reference to the drawings and particularly FIG. 1, ash from a recovery boiler is directed into tank 20 where the ash is dissolved in water. In some cases, all or substantially all of the ash from the recovery boiler is directed into tank 20. In other cases, only a portion of the ash from the recovery boiler is directed into tank 20. In any event, ash directed into tank 20 is dissolved to form a dissolved ash solution. The dissolved ash solution is directed to an evaporator or a series of evaporators 22. Evaporators 22 concentrate the dissolved ash solution to form a concentrated dissolved ash solution (purge stream) and a concentrate containing a mixture of sodium sulfate and burkeite (2Na2SO4·Na2CO3) crystals. The concentrated dissolved ash solution is typically relatively rich in chloride and potassium. The concentrate produced by the evaporators 22 is directed to a solid-liquid separator 24 which separates burkeite and sodium sulfate crystals from a mother liquor. The burkeite and sodium sulfate are typically returned to the wood pulping operation. The mother liquor produced by the solid-liquid separator 24 can be returned via line 26 back to the first stage evaporator or evaporators 22.

As shown in FIG. 1, the purge stream in the form of the concentrated ash solution is directed through line 25 to a glaserite crystallizer 28. Once in the crystallizer 28, the concentrated ash solution is subjected to cooling, and preferably adiabatic cooling. Adiabatic cooling is the decrease of the temperature of the system without the removal of heat from the system. One common method of adiabatic cooling is to lower the pressure in the crystallizer, and since the temperature and pressure of a closed system are directly proportional, decreasing one will result in the decrease of the other. In one embodiment, the adiabatic cooling process in the glaserite crystallizer 28 is carried out until the crystallizer reaches a temperature of approximately 50 °C. In the crystallizer 28, the adiabatic cooling process will cause glaserite to crystallize. This forms a concentrated glaserite slurry that is directed from the crystallizer 28 to a solid-liquid separator 30. In the process of adiabatically cooling the concentrated ash solution in stream 25, crystallizer 28 produces a purge stream 32. Purge stream 32 includes a relatively rich concentration of chloride. Purge stream 32, having the relatively rich concentration of chloride, can be further treated or disposed by conventional means. As suggested in FIG. 1, a portion of the concentrated purge stream 32 can be recycled via line 34 to the evaporators 22. The amount of the purge stream 32 directed from the plant or recycled back to evaporators 22 can vary depending on the concentration of chloride in stream 32, as well as the concentration of chloride in the dissolved ash solution.

Glaserite slurry produced by the adiabatic cooling crystallizer 28 is directed to a solid-liquid separator 30. Various types of solid-liquid separators can be employed, such as filters, centrifuge, etc. In any event, the solid-liquid separator 30 separates the glaserite crystals from the glaserite slurry. The glaserite crystals are then directed into a SOP crystallizer 38. As described more fully below, the function of the SOP crystallizer is to recover SOP from the glaserite crystals. To accomplish this, a water source is directed to a chiller 50. The chiller 50 is employed to chill the water to a temperature in the range of 0 °C to 25 °C. This produces chilled water. The chilled water from the chiller 50 is directed into the SOP crystallizer 38. Here, the glaserite crystals are contacted with the chilled water. Once the glaserite crystals contact the chilled water in the SOP crystallizer, both sodium sulfate and the potassium sulfate in the glaserite crystals dissolve into the chilled water. After dissolving, the potassium sulfate re-crystallizes in the SOP crystallizer as SOP. However, when enough water is added to dissolve the sodium sulfate there will be extra SOP remaining as crystals. Hence, what is left in the SOP crystallizer is a sodium sulfate- and SOP solution containing re-crystallized SOP.

The re-crystallized SOP is recovered through a process where the sodium sulfate-rich solution is directed to a solid-liquid separator 40 which separates the re-crystallized SOP from the sodium sulfate-rich solution. As FIG. 1 depicts, the sodium sulfate solution will contain a significant amount of potassium sulfate. This solution can be recycled via line 42 back to the glaserite crystallizer 28.

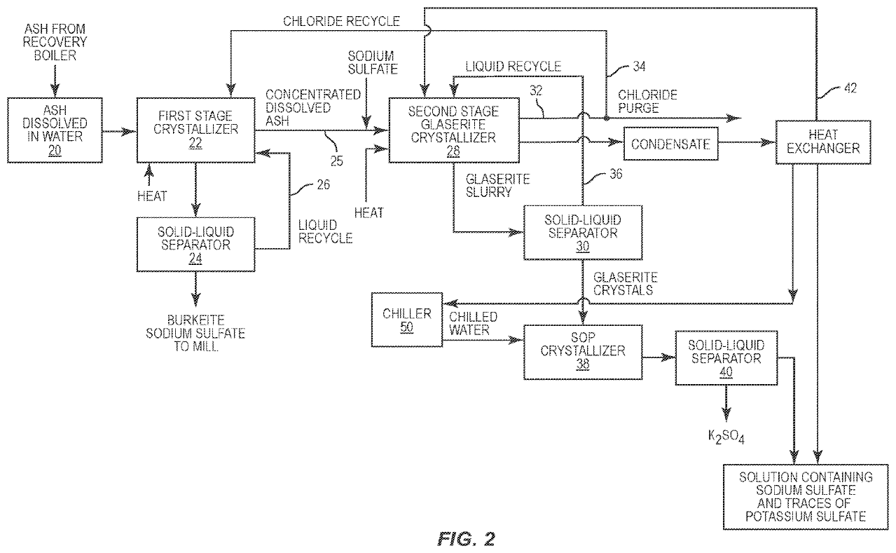

Now turning to FIG. 2, this represents another embodiment of the present invention which is similar in many respects to that shown in FIG. 1 and described above. However, there are a few distinctions. The solid-liquid separator 30 in FIG. 2 separates the glaserite slurry into glaserite crystals and a liquid recycle stream 36. In the embodiment illustrated in FIG. 2, the liquid recycle stream is recycled back to the crystallizer 28.

Also, as illustrated in FIG. 2, the glaserite crystallizer 28 produces a condensate. The condensate is directed through a heat exchanger that cools the condensate. From the heat exchanger, the condensate is directed to the chiller 50 which further cools the condensate to approximately 0 °C to 25 °C as described above. This forms the chilled water that is directed into the SOP crystallizer 38 discussed above.

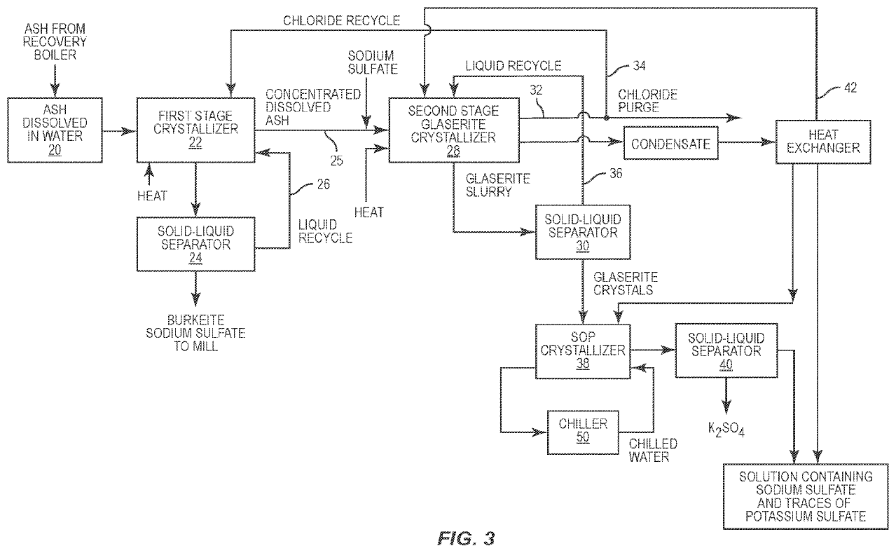

The FIG. 3 embodiment is similar to the process shown in FIG. 2 and described above. However, in the FIG. 3 process, the chiller 50 is placed in a recirculation line around the SOP crystallizer 38. Hence, the aqueous solution in the SOP crystallizer is circulated through the chiller 50. The function of the chiller is to chill the solution in the SOP crystallizer 38 to a temperature in the range of −10 °C to 25 °C. This temperature range is sufficient to dissolve the glaserite crystals into a sodium sulfate and potassium sulfate solution but enables the dissolved potassium sulfate to be re-crystallized as SOP in the SOP crystallizer. As discussed above, this will effectively leave a sodium sulfate-rich solution containing re-crystallized SOP in the SOP crystallizer 38. Typically, the solution in the SOP crystallizer 38 is a mixture of water or condensate and brine. In this case condensate from the glaserite crystallizer is fed into the SOP crystallizer 38 while the brine is clarified effluent produced by the SOP crystallizer.

Some lab tests verify the effectiveness of the SOP recovery process discussed above. Before discussing the tests, it is noted that in glaserite crystals the ratio of sodium to potassium is not always the same. In these lab tests, the glaserite used comprised 73.8 wt. % K₂SO₄ and 26.2 wt. % sodium sulfate. The tests were conducted based on adding enough water to dissolve substantially all of the glaserite. It is noted, however, that in a commercial operation, one could elect to add sufficient water to get the sodium concentration to below 2% of the product SOP in order to have a reasonable reaction time. In the first test, 100 g of glaserite crystals was contacted with 492 g of water at 50 °C. All of the sodium sulfate was dissolved, as well as 71.1 g of potassium sulfate. This left 2.7 g of potassium sulfate or a yield of 2.7%. In the second test, 100 g of glaserite was contacted with 490 g of water at 35 °C. This dissolved all of the sodium sulfate and dissolved 60.4 g of potassium sulfate. This left 13.4 g of potassium sulfate or a yield of 13.4%. In the final test, 100 g of glaserite was contacted with 504 g of water at 5 °C. This dissolved all of the sodium sulfate, as well as 42.2 g of potassium sulfate. This left 31.6 g of potassium sulfate or a yield of 31.6%.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A process for recovering sulfate of potash (SOP) from ash produced in a wood pulping operation, the process comprising:
recovering ash containing potassium, chloride, sulfate carbonate and sodium from a recovery boiler of the wood pulp operation;
mixing the ash with an aqueous solution to form a dissolved ash solution;
concentrating the dissolved ash solution in an evaporator to form a concentrated dissolved ash solution;
directing the concentrated dissolved ash solution to a glaserite crystallizer and producing a glaserite slurry containing glaserite crystals;
separating the glaserite crystals from the glaserite slurry;
directing water to a chiller;
chilling the water in the chiller to a temperature of 0 °C to 25 °C to form chilled water;
directing the chilled water and glaserite crystals into an SOP crystallizer and contacting the glaserite crystals with the chilled water;
dissolving the glaserite crystals in the chilled water in the SOP crystallizer to yield a solution containing sodium sulfate and potassium sulfate;
re-crystallizing a portion of the potassium sulfate as SOP in the SOP crystallizer, yielding a sodium sulfate-rich solution in the SOP crystallizer; and
directing the sodium sulfate-rich solution containing the re-crystallized SOP to a solid-liquid separator and separating the re-crystallized SOP from the sodium sulfate-rich solution.

2. The process of claim 1 wherein the water directed to the chiller originates as a condensate produced by the glaserite crystallizer.

3. The process of claim 2 wherein the condensate is directed through a heat exchanger before being directed into the chiller.

4. The process of claim 1 further including recycling the sodium sulfate-rich solution to the glaserite crystallizer.

5. A process for recovering sulfate of potash (SOP) from ash produced in a wood pulping operation, the process comprising:
recovering ash containing potassium, chloride, sulfate carbonate and sodium from a recovery boiler of the wood pulp operation;
mixing the ash with an aqueous solution to form a dissolved ash solution;
concentrating the dissolved ash solution in an evaporator to form a concentrated dissolved ash solution;
directing the concentrated dissolved ash solution to a glaserite crystallizer and producing a glaserite slurry containing glaserite crystals;
separating the glaserite crystals from the glaserite slurry;
directing the glaserite crystals into an SOP crystallizer containing an aqueous solution;
chilling the aqueous solution in the SOP crystallizer by directing the aqueous solution through a chiller to produce a chilled aqueous solution that is directed back into the SOP crystallizer;
chilling the aqueous solution in the chiller sufficient to maintain the temperature of the aqueous solution in the SOP crystallizer at a temperature of −10 °C to 25 °C;
dissolving the glaserite crystals in the chilled aqueous solution in the SOP crystallizer to yield an aqueous solution containing sodium sulfate and potassium sulfate;
re-crystallizing a portion of the potassium sulfate as SOP in the SOP crystallizer, yielding an aqueous solution rich in sodium sulfate in the SOP crystallizer; and
directing the aqueous solution rich in sodium sulfate and containing the re-crystallized SOP to a solid-liquid separator and separating the re-crystallized SOP from the aqueous solution that is rich in sodium sulfate.

6. The process of claim 5 further including recycling the aqueous solution rich in sodium sulfate to the glaserite crystallizer.

7. The process of claim 5 including forming the aqueous solution in the SOP crystallizer by mixing water with a brine produced by the SOP crystallizer.

8. The process of claim 1 wherein a portion of the potassium sulfate remains dissolved after said portion of the potassium sulfate has re-crystallized.

9. The process of claim 5 wherein a portion of the potassium sulfate remains dissolved after said portion of the potassium sulfate has re-crystallized.
